(19) United States
(12) Patent Application Publication
(10) Pub. No.: US 2004/0034149 A1
(43) Pub. Date: Feb. 19, 2004

(54) Essential oils in plastic film

(76) Inventor: Rod A. Garcia, Montgomery, TX (US)

Correspondence Address: Kurt S. Myers, 7634 Braesdale, Houston, TX, 77071, US

(21) Appl. No.: 10/412,493

(22) Filed: Apr. 12, 2003

Related U.S. Application Data
(60) Provisional application No. 60/404,049, filed on Aug. 16, 2002.

(51) Int. Cl. C08K 5/01; C08K 3/34

(52) U.S. Cl. 524/474; 524/492

(57) ABSTRACT

The present invention is directed to a plastic film having incorporated in the film at least one essential oil. The film may be made into bags, liners or covers which protect and preserve horticulture products and foods. The essential oil filled films are used as pre-harvest bags, such as banana bags for protecting fruit on the tree, or as harvest films or bags to repel bugs and insects entering the harvesting gathering containers or as a post-harvest bag to preserve the fruit as it travels to market; as liners in the usual corrugated paper or cardboard boxes that ship foods; or as sheets that cover flowers or food, especially fruits to protect against insects.

### RELATED APPLICATION

This application is based on provisional application Serial No. 60/404,049, filed Aug. 16, 2002.

### FIELD OF THE INVENTION

The present invention is directed to the incorporation of essential oils in plastic film. The essential oil films of the present invention will protect and preserve goods, especially horticulture products, covered by the film.

### BACKGROUND OF THE INVENTION

U.S. Pat. No. 3,244,586 discloses o-pyridyl phosphates and phosphorothioates as pesticide compounds. These compounds are incorporated into films and are used presently in banana bags using the commercially available product Dursban® insecticide, a trademark of Dow Chemical Company.

U.S. Pat. No. 3,567,119 discloses methods for the incorporating of fragrance compounds or oil bouquets and/or topical antifungal or antibacterial agents, insect repellant compounds and certain odoriferous medicaments into polymeric or natural materials so that the fabricated product possesses the properties imparted by the additive or additives for a long period of time.

U.S. Pat. No. 3,655,129 discloses methods of making cast films that contain various volatilizable liquids that permeate slowly through and out of the films.

U.S. Pat. No. 3,685,734 discloses an assembly of a smooth-surfaced layer of soft vinyl plastisol containing a fragrance or other volatile organic substance coated on a base and protectively covered with a smooth flexible sheet having low vapor transmission.

U.S. Pat. No. 4,159,314 discloses an insect repellant animal collar wherein a strip of flexible polymeric material adapted to be worn on the neck of the animal is impregnated with a thujane derivative.

U.S. Pat. No. 4,320,112 discloses a receptacle such as a plastic trash can or bag that contains an insect and animal repellent for ridding areas containing the receptacles of annoying insects and for preventing animals from turning over or destroying the receptacles when full.

U.S. Pat. No. 4,871,541 discloses a process involving forming a clathrate compound of fenitrothion with cyclodextrin or a starch decomposition product containing cyclodextrin and granulating into a dry powder, melt-mixing the dry powder with a synthetic material and molding the mixture into pellets. The pellets are molded in the form of film by calendaring or by extrusion molding.

U.S. Pat. No. 4,888,174 discloses a method of retarding the rate of migration of O-halopyridl phosphate insecticide from polyethylene articles.

U.S. Pat. No. 5,246,919 discloses a fragrant material that is comprised of an aggregate of small sodium chloride granules and having a fragrant oil and optionally a water soluble dye dispersed in the material.

U.S. Pat. No. 5,688,509 discloses a controlled-release insect repellent device that comprises an insect repellent composition contacting a substrate. The repellent compound may be chosen from the group consisting of essential oils and active ingredients of essential oils.

U.S. Pat. No. 5,885,600 discloses a composition that has insect repellent properties made from cold processed extracted oils and an antioxidant, particularly from a combination of Neem, Citronella and Cedar wood oils.

U.S. Pat. No. 6,270,753 discloses a fragrance-containing composition for paper substrates consists essentially of a polyvinyl chloride (PVC) plastisol and one or more fragrances, for example, an insect repellent.

U.S. Pat. No. 6,346,297 discloses a method of coating a paper substrate with a composition that consists essentially of a polyvinyl chloride (PVC) plastisol and one or more fragrances, for example, an insect repellent.

### SUMMARY OF THE INVENTION

The present invention is directed to a plastic film having incorporated in the film at least one essential oil. The film may be made into bags, liners or covers which protect and preserve horticulture products and foods. The essential oil filled films are used as pre-harvest film, such as producing banana bags for protecting fruit on the tree from insects that attack the bananas, or as harvest films to prevent flying bugs or insects entering the harvesting gathering containers or as a post-harvest film to preserve the fruit as it travels to market; such as liners in the usual corrugated paper or cardboard boxes that ship foods; or as sheets or bags that cover flowers or food, especially fruits to protect against insects. The films of the present invention may be made from biodegradable resins such that films having an essential oil incorporated into the film may be used as a cover for planting strawberries or other crops that need protection from the insects in the soil. Films of the present invention may also have dispersed in the film an ethylene absorber that will extend the shelf life of the fruit packaged in the film of the present invention.

### BRIEF DESCRIPTION OF THE DRAWINGS

FIG. 1 shows a schematic of a melt blowing apparatus for making blown film.

FIG. 2 shows a schematic of a cast film line for making multi-layer cast films.

### BRIEF DESCRIPTION OF THE EMBODIMENTS OF THE INVENTION

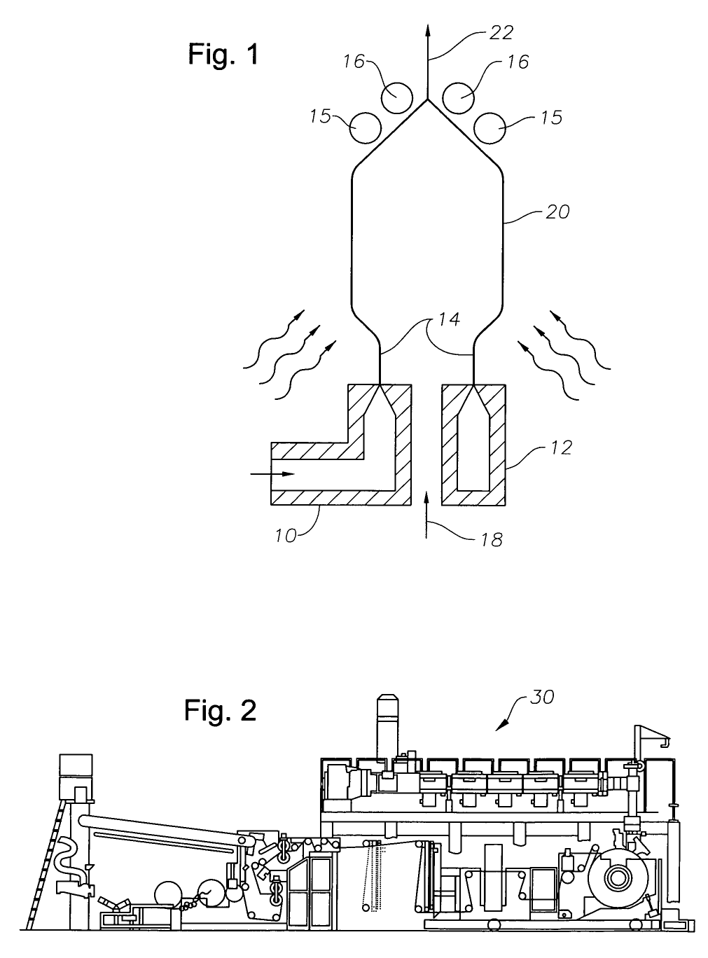

Large volume of polymer films are manufactured by film blowing (blown film extrusion). Referring to FIG. 1, a single screw extruder 10 is used to melt each polymer making up the film and pump the polymer into a tubular die block 12. An extruded tube 14 of polymer is forced out the die 12 and the initial polymer is grasped to close the upper end of the tube 14 and drawn upward between nip rollers 16. Air is blown through an opening 18 in the die 12 to the center of the extruded tube 14 and the tube is extended upward and outward to form a bubble 20. Extension of the melt in both the radial and down-stream direction stops at the freeze line (frost line) due to crystallization of the melt. The nip rolls 15, 16 collect the film product 22, as well as sealing the top of the bubble 20 to maintain the air pressure inside the bubble 20. The film product 22 is passed over or under rollers to bring the product 22 back to floor level to be rolled on high speed winders (not shown) to collect the film as large rolls. Alternately, the film may pass through splitters, bag making equipment, or other equipment known to the art. To produce multi-layer film, a separate extruder for each layer of film grade resin forces the respective resin into the die block 12. Rather than a single layer of resin forming the tube 14, two or more molten polymer layers are combined into concentric circles or a layered tube which emerges from the die block 12. The multi-layered tube is blown into a bubble 20 similarly as shown in FIG. 1. The apparatus for producing blown film is known to the art and is set forth herein to provide a background understanding for the unique products of the present invention.

Referring now to FIG. 2, a cast film apparatus 30 is shown as illustrative of apparatus known to the art. The shown cast film machine 30 (details found at http://www.primplast.com/DATA2000.htm which are incorporated herein by reference) is designed to produce a three layer film. The cast film structure is A 15-20% B 70-60% C 15-20%, meaning that A is one cast film resin, B is a different cast film resin and C either the same as A or still a different film resin. Available commercially are cast resin machines for producing a single layer or over 6 (six) layers in the cast film. The apparatus for producing cast film is known to the art and is set forth herein to provide a background understanding for the unique products of the present invention.

The first step in making the unique products of the present invention is to take one or more essential oil and incorporate the oil(s) into a free flowing solid concentrate. An “essential oil”, as used herein, is any essential oil including any of the more than thirty commercially available essential oils such as almond oil, anise oil, bay oil, caraway oil, cardamon oil, cedar oil, celery oil, chamomile oil, cinnamon oil, citronella oil, clove oil, coriander oil, corn oil, cottonseed oil, cumin oil, dill oil, eucalyptus oil, fennel oil, garlic oil, geranium oil, ginger oil, grapefruit oil, lemon oil, lime oil, linseed oil, mint oil, parsley oil, pepper oil, peppermint oil, rose oil, rosemary oil, sesame oil, soybean oil, spearmint oil, orange oil, thyme oil, tumeric oil, wintergreen oil (oil of wintergreen) or any of the natural or synthetic active ingredients in essential oils such as citronellal, methyl salicylate, ethyl salicylate, propyl salicylate, citronellal, safrole and D-limonene.

The liquid essential oils are compounded into a free flowing solid concentrate so that these oils may be easily incorporated with or dispersed in a film forming resin before or in the film-forming process. The free flowing concentrate containing the essential oil (s) and the film resin are introduced into an extruder, fully dispersing the essential oil as an additive concentrate in the film forming resin, to produce the films of the present invention. Plastic films are either blown films or cast films, depending on the specific film resins used, the equipment used and the end-use of the plastic film. Examples of film forming resins are polyolefins, such as polyethylene or polypropylene, polyester, nylon, polycarbonate, polystyrene, poly-vinyl chloride, and acid type polymers such as EAA, EVA, EMA, EFA and the derivatives of these polymers. The additive concentrate composition is influenced by the type resin to be used, the film forming process used and the temperature conditions of the extruder used to form the film. Since the essential oils are aromatic liquids that are volatile, two considerations are considered in the choice of materials to be used to make the free flowing solids incorporating the essential oil. First, a carrier material that is porous or of high surface area is used to incorporate or compound the essential oil into the carrier. A second consideration is the compatibility of the carrier in the free flowing concentrate with the resin and process in which it is used. The concentrate of carrier and essential oil is dispersed within the film resin during the film forming process and optimum conditions will minimize the diffusing of the essential oil from the film in the short time after being in the presence of the extruder temperatures of the film forming process. Carriers such as porous resins, such as micro porous linear low density polyethylene (LLDPE), low density polyethylene (LDPE), EVA, nylon, polystyrene; or high structured or high surface area silica such as Hubersorb 600 (a product of J. M. Huber Corp.) and diatomaceous earth such as Microcel E (a product of Johns Mansville); or wax such as polyethylene wax (low molecular weight polyethylene); styrene modified polymers and copolymers such as styrene-ethylene-butylene polymers such as Kraton resins (products of Shell Chemical Company), styrene-isoprene copolymers, styrene-ethylene-propylene block copolymers and styrene-butadiene copolymers such as K resins; or natural or synthetic zeolites are used to produce the concentrates.

To illustrate the variety of production methods to produce the concentrates used in the present invention, the following examples are given:

### EXAMPLE 1

| | 1A | 1B | 1C |
|---|---|---|---|
| MP300* | 40 grams | 30 | 20 |
| Cedar oil | 60 grams | 70 | 80 |

*MP300 is a micro porous LLDPE pellet sold by Akzo Nobel

This example illustrates that the essential oil, cedar oil, is blended with the carrier and that concentrations of up to 80 wt % oil in the carrier produced a free flowing solid concentrate. A similar result is obtained using other essential oils, Other porous resins are commercially available, such as porous polypropylene, EVA and HDPE or LDPE to mention a few.

### EXAMPLE 2

| | 2A | 2B | 2C |
|---|---|---|---|
| Cedar oil | 10 grams | 30 | 50 |
| 9820* | 90 grams | 70 | 50 |

*9820 is a polyethylene of Union Carbide

The polyethylene and cedar oil are blended in a Henchel or high intensity mixer and then compounded through a twin-screw compounder (extruder). Instead of using a high intensity mixer, the oil can be injected down steam on the twin-screw extruder after the resin is melted to be fully mixed or incorporated into the resin. The concentrate is either cut under water or strand cut in pellets. The pellets are free flowing solids containing up to 50 wt % essential oil.

This example illustrates that a free flowing solid pellet is produced by compounding in an extruder. Other resins such as low density polyethylene (LDPE), EVA, polypropylene, polystyrene and nylon are used in place of the LLDPE to produce the essential oil concentrates of the present invention. Other essential oils such as wintergreen, D-limonene, eucalyptus, garlic, and peppermint are used in place of the cedar oil.

### EXAMPLE 3

| | 3A | 3B | 3C |
|---|---|---|---|
| Cedar Oil | 50 grams | 60 | 80 |
| Hubersorb 600* | 50 grams | 40 | 20 |
| | 3X | 3Y | 3Z |
| Cedar Oil | 50 grams | 60 | 80 |
| Micro-cel** | 50 grams | 40 | 20 |

*Hubersol 600 is a silica product of J. M. Huber Corp. and
**Microcel is a silica product of Johns Manville

This example illustrates that a free flowing solid concentrate is produced by mixing with a high surface area silica material. Theses concentrates are compatible with the plastic resins to form finished film products containing the essential oil.

### EXAMPLE 4

In a pellet mill (California pellet mill type) is placed 35 gr. cedar oil, 45 gr. of film grade polyethylene, and 20 gr. polyethylene wax to produce a free flowing pellet This example illustrates that a free flowing solid pellet is produced by compounding in a pellet mill using wax to form a concentrate for processing film at low temperature. Steric acid may replace all or some of the wax as a binder or carrier.

### EXAMPLE 5

Film samples are prepared as follows:

Samples A, B, & C were produced from 50 wt % cedar oil concentrate

Sample D was produced from a 70 wt % cedar oil concentrate

Sample E was produced from a 60 wt % cedar oil concentrate

Concentrate resin was LLDPE micro porous polyethylene, a product of Akzo Nobel

| | 5A | 5B | 5C | 5D | 5E |
|---|---|---|---|---|---|
| LDPE * | 2.8 pound | 2.8 | 2.8 | 2.8 | 0 |
| 4903** | 1.2 pound | 1.2 | 1.2 | 1.2 | 4.0 |
| Cedar conc. | 5 gram | 10 | 20 | 50 | 70 |
| % oil in film | 0.19 | 0.37 | 0.74 | 1.9 | 2.6 |

*film grade LDPE of Dow Chemical Company;
**LDPE of Phillips Chemical Company.

These samples are run in a film blowing apparatus making film at approximately 1 mil thickness.

This example illustrates that film is produced with concentrates of various concentrations of cedar oil. Film is produced at three levels of cedar oil: 1.5 wt %, 3.0 wt % and 4.0 wt %. The film may be made into banana bags, tubular with both ends open and having a plurality of openings in the film. The bags are placed over the banana bunch on the tree to repel insects and protect the bananas from flying creatures such as birds and bats while still green. Produce bags made of the film were found to extend the shelf life of harvested bananas.

### EXAMPLE 6

| | 6A | 6B | 6C | 6D |
|---|---|---|---|---|
| 4903* | 1.2 pound | 1.2 | 1.2 | 1.2 |
| 1539** | 2.8 pound | 2.8 | 2.8 | 2.8 |
| M B*** | 120 grams | 120 | 60 | 60 |
| Green color | | 60 grams | | 30 |

*4903 is a LDPE of the Phillips Chemical Company;
**1539 is a LLDPE of Union Carbide Company; and
***is a Master Batch of 35 wt % cedar oil, 50 wt % LDPE and 15% Mirocel E Silica, a product of Johns Mansville.

The foregoing examples are repeated with the following master batch or concentrates using styrene modified polymers as the carrier to make the free flowing concentrate:

| 6E | | 6F | | 6G | |
|---|---|---|---|---|---|
| Vector 4113 | 40 wt % | Vector 4211 | 40 wt % | Vector 6030-D | 40 wt % |
| Cedar Oil | 60 wt % | Wintergreen | 60 wt % | D-limonene | 60 wt % |

Vector 4113 (SIS/SI) is a linear styrene-isoprene-styrene triblock/styreneisoprene diblock copolymer
Vector 4211 (SIS) is a styrene-isoprene-styrene linear triblock copolymer
Vector 6030-D (SBS) is a styrene-butadiene block copolymer

| 6H | | 6J | | 6K | |
|---|---|---|---|---|---|
| Vector 2518 | 40 wt % | KR03 | 40 wt % | G1650 | 40 wt % |
| Eucalyptus | 60 wt % | Cedar | 60 wt % | Garlic | 60 wt % |

Vector 2518 (SBS) is a styrene-butadiene-styrene triblock copolymer
KR03 is a styrene-butadiene copolymer (K-resin) from Phillips
G1650 (SEBS) is a styrene-ethylene-butylene block copolymer from Shell

6M

| | |
|---|---|
| G1701X | 40 wt % |
| Peppermint | 60 wt % |

G1701X (SEP) is a styrene-ethylene-propylene block copolymer

These samples are run in a film blowing apparatus with the film resin mixed with the free flowing concentrate in the extruder making film at approximately 1 mil thickness. Films may range in thickness between 0.5 mil and 50 mil.

The foregoing examples illustrate the production of a free flowing solid concentrate of one essential oil and incorporated with or dispersed in a film forming resin before or in the film-forming process to produce a plastic film containing the essential oil. However, more than one essential oil may be incorporated into the film. The essential oils are not equivalent in the repelling of a particular insect, one essential oil may have more power on certain insects than another oil. Also the effect on the product being protected is different with different essential oils. The following examples illustrate that more than one essential oil may be incorporated in or dispersed within a film.

### EXAMPLE 7

Sample A cedar oil+wintergreen oil+resin+green color

Sample B cedar oil+D-limonene oil+resin+green color

Sample C cedar oil+eucalyptus oil+resin+green color

Sample D wintergreen oil+D-limonene oil+resin+green color

Sample E wintergreen oil+eucalyptus oil+resin+green color

Sample F D-limonene oil+eucalyptus oil+resin+green color

| | 7A | 7B | 7C | 7D | 7E | 7F |
|---|---|---|---|---|---|---|
| 4903* | 1.2 pounds | 1.2 | 1.2 | 1.2 | 1.2 | 1.2 |
| 1539** | 2.8 pounds | 2.8 | 2.8 | 2.8 | 2.8 | 2.8 |
| Cedar*** | 30 grams | 30 | 30 | | | |
| Wg*** | 30 grams | | | 30 | 30 | |
| D-limonene*** | | 30 grams | | 30 | | 30 |
| Eucalyptus*** | | | 30 grams | | 30 | 30 |
| Green Color | 25 grams | 25 | 25 | 25 | 25 | 25 |

*4903 LDPE of Philips Chemical Co.;
**1539 LLDPE of Union Carbide Co.;
***a concentrate of 60 wt % oil and 40 wt % porous PE resin

Each of the above samples is blown into green film. This example illustrates that films containing more than one essential oil may be made. Films with more than one essential oil will have different degrees of freshness and odor and insect repelling characteristics. The film may be run through bag making apparatus to make bags for fruit such as grapes or used to keep products, such as cut flowers, insect free.

### EXAMPLE 8

This examples illustrates that as many as four different essential oils may be incorporated into a film.

| | 8A | 8B | 8C | 8D |
|---|---|---|---|---|
| 1539* | 4.0 pounds | 4.0 | 4.0 | 4.0 |
| Cedar** | 30 grams | 30 | 0 | 30 |
| D-limonene** | 30 | 0 | 30 | 30 |
| Eucalyptus** | 30 | 30 | 30 | 30 |
| Wintergreen** | 0 | 30 | 30 | 30 |
| Green color | 25 grams | 25 | 25 | 25 |

*1539 LLDPE of Union Carbide;
**a concentrate of 50 wt % oil and either MP300 or styrene modified polymer.

### EXAMPLE 9

This example illustrates still another group of carriers that are used in producing the essential oil concentrates of the present invention. These natural and synthetic zeolites provide a time delay to the evaporation of the essential oil.

| | 9A | 9B |
|---|---|---|
| Zeodex 110-40* | 50 wt % | 40 wt % |
| Essential oil** | 50 wt % | 60 wt % |

*a natural zeolite from Zeodex International
**an essential oil selected from the group of cedar oil, wintergreen, D-limonene, eucalyptus, garlic and peppermint.

| | 9C | 9D |
|---|---|---|
| Abscents 300* | 50 wt % | 40 wt % |
| Essential oil** | 50 wt % | 60 wt % |

*a synthetic zeolite from UOP
**an essential oil selected from the group of cedar oil, wintergreen, D-limonene, eucalyptus, garlic and peppermint.

The above concentrates are incorporated with a film resin, I.e. polyethylene, in an extruder making blown film of approximately 1 mil thickness.

The large number of carrier materials are illustrated in the foregoing examples and the films made were blown films. However, these examples are only illustrative of the essential oils that may be used and the specific concentrations are illustrative. Concentrates having up to 60 wt % oil are employed in film samples. The range is 1 wt % to 60 wt %. The carrier is employed in a range of 1 wt % to about 50 wt % of the concentrate. The film resins need not be those in the respective examples but any resin that is commercially used to blow film may be substituted in the example. As mentioned herein before, instead of blown film resins, the concentrates illustrated above are used in cast film. Thus, a polyethylene cast film from the concentrate examples above rather than a blown film may be made.

The choice of film resin allows distinct end products to be made. The above examples are illustrative of film that may be made into bags. Also the blown films may be split to produce sheets that are useful as wrapping material, liners to paper products or are used as mulching film, I.e. film laid on the ground for a horticultural product, e.g. strawberries planted in openings in the film.

Cast films are used in many of the same end uses. An example of a polypropylene woven bag is illustrated in the following example:

### EXAMPLE 10

Into a cast film extruder is introduced:

| | |
|---|---|
| HGZ 120-01* | 96 wt % |
| Concentrate containing cedar oil** | 4 wt % |

*HGZ 120-01 is a nominal 12 mf polypropylene homopolymer from Phillips
**concentrate contains 60 wt % cedar oil and 40 wt % porous polypropylene, MP 100 from Akzo Nobel,

A film is made and slit into strips. The strips are wound on bobbins and placed in a weaving machine to make bags. These woven bags are especially suitable for transporting grain, such as rice, and repelling insects and bugs.

Other resins may be used to produce woven bags such as polyethylene or polyesters. More than one essential oil may be used.

Another choice in resin are the degradable resins and specifically the biodegradable resins. These resins are used to make an improved mulching film and are illustrated in the following examples:

### EXAMPLE 11

| 11A | | 11B | |
|---|---|---|---|
| Tone 737* | 96 wt % | DuPont/Dow PLA** | 96 wt % |
| Cedar oil | 4 wt % | Cedar oil | 4 wt % |

| 11C | |
|---|---|
| Capra FB 100*** | 96 wt % |
| Cedar oil | 4 wt % |

*Tone 737 is a high molecular weight polyester containing polycaprolactone from Union Carbide
**Dupont/Dow PLA is a biodegradable resin containing polylactic acid, a derivative of corn fermentation from DuPont or Dow
***Capra FB 100 is a polylactone from Solvay

This example illustrates the introduction of the essential oil into the melt blowing film extruder at a point in the extruder where the biodegradable resin is in a melt form and the essential oil is mixed in the extruder with the resin. The multi-layer film product is an improved mulching film since it will biodegrade in the field after the short growing period of the horticulture product, such as strawberries. The essential oil will act as a repellant to the insects that are in the soil.

Multi-layer films are a unique product of the present invention. The multi-layer films are produced by blowing the film or by casting the films. Each layer of the multi-layer film may contain an essential oil. On the other hand, the essential oil may be in a layer of the film and at least one barrier layer or barrier layers on both sides complete the multi-layer film. The barrier layer may be a substantial barrier due to the choice of barrier resin or the thickness of the layer or may just slow the diffusion of the essential oil to the outside surface. Specifically, a banana bag is produced from a multi-layer film with one outside layer being a significant barrier layer. The reason for such a bag is that when the bag covers the bananas, the diffusion of the essential oil is desired primarily toward the inside layer, in the direction toward the bananas, to rid the banana bunches of mites and lepidopteran larvae. Multi-layer films are used to control the essential oil diffusion over a longer period of time and in the desired direction. Multi-layer blown films are illustrated in the following examples:

### EXAMPLE 12

A three layer blown multiplayer film is made as follows:

| | | |
|---|---|---|
| Outer layer | HGZ 120-01* | 70 wt % |
| Center layer | LDPE/cedar oil conc (60 wt %)\hat{ } | 4 wt % |
| Inner layer | Capron 8202** | 26 wt % |

*HGZ 120-01 is a polypropylene from Phillips
\hat{ }see example 5E
**Capron 8202 is a nylon 6 from Honeywell

The choice of barrier resins is any resin that may be melt blown and the choice of amount of resin in any layer may vary from 1 to 80 wt %. These multiplayer films are suitable for making banana bags.

The rate of dispersion of the essential oil from the film may be time delayed by the choice of the outer layers of film, with the layer containing the essential oil in the middle layer of the film.

### EXAMPLE 13

Another three layer blown multiplayer film is illustrated as follows:

| | | |
|---|---|---|
| Outer layer | Capron 8202* | 48 wt % |
| Center layer | LDPE/Cedar oil (60 wt %)\hat{ } | 4 wt % |
| Inner layer | Capron 8202* | 48 wt % |

\hat{ }see Example 5E
*Capron 8202 is a nylon 6 from Honeywell

Nylon 6 is used as a single illustration; however, the barrier layer resin may be any melt blown resin.

### EXAMPLE 14

A four layer blown multi-layer film is illustrated as follows:

| | | |
|---|---|---|
| Outer layer | Zytel 101* | 48 wt % |
| Center layer | HGZ 120-01** | 20 wt % |
| Center layer | LDPE/Cedar oil concentrate (60 wt %)\hat{ } | 4 wt % |
| Inside layer | EVOH*** | 28 wt % |

*Zytel 101 is a nylon 66 from DuPont
**HGZ 120-01 is a polypropylene from Phillips
\hat{ }see Example 5E
***is a Evala LH101BD ethylene-acetate/vinyl alcohol barrier copolymer resin from Evala of America

This example illustrates a film with a substantial barrier in one direction and an. inside layer with a cling characteristic that for example may be used to wrap a pallet of food products to deter infestation of insects.

### EXAMPLE 15

A five layer blown multiplayer film is illustrated as follows:

| | | |
|---|---|---|
| 1^{st} layer | Surlyn 8020* | 20 wt % |
| 2^{nd} layer | EVA** | 20 wt % |
| 3^{rd} layer | LDPE/cedar oil concentrate (60 wt %)\hat{ } | 4 wt % |
| 4^{th} layer | EVA/wintergreen concentrate (60 wt %)# | 4 wt % |
| 5^{th} layer | EVOH*** | 52 wt % |

*Surlyn 8020 is a sodium ionomer containing ethylene - methyl acrylic acid from DuPont
**EVA is Elvax 470 is 18% ethyl acetate in polyethylene resin from DuPont
\hat{ }see Example 5E
# is similar to Example 5E with EVA substituted for LDPE and wintergreen for cedar oil
***is a Evala LH101BD ethylene-acetate/vinyl alcohol barrier copolymer resin from Evala of America

This example illustrate a film with more than one essential oil.

The following examples illustrate blown multi-layer film using biodegradable resins:

### EXAMPLE 16

A three layer blown multi-layer film is illustrated as follows:

| | | |
|---|---|---|
| 1^{st} layer | FB 100* | 48 wt % |
| 2^{nd} layer | PLA** | 48 wt % |
| 3^{rd} layer | LDPE/cedar oil concentrate (60 wt %)\hat{ } | 4 wt % |

*Capra FB 100 is a polylactone from Solvay
**see Example 11
\hat{ }see Example 5E

This example illustrates a multiplayer film with the essential oil at an outer layer

### EXAMPLE 17

Another three layer blown multiplayer film is illustrated as follows:

| | | |
|---|---|---|
| 1^{st} layer | Tone 787* | 48 wt % |
| 2^{nd} layer | Tone 787*/cedar oil conc. (60 wt %)\hat{ } | 4 wt % |
| 3^{rd} layer | Tone 787* | 48 wt % |

*Tone 787 is a high molecular weight polyester containing polycaprolactone from Union Carbide
\hat{ }similar to Example 5E with Tone 787 substituted for LDPE

This example illustrates a film from a single film resin with the essential oil encapsulated in the inner film.

### EXAMPLE 18

A four layer blown multiplayer film is illustrated as follows:

| | | |
|---|---|---|
| 1^{st} layer | Capa FB100* | 46 wt % |
| 2^{nd} layer | Tone 787/cedar oil conc. (60 wt %)** | 4 wt % |
| 3^{rd} layer | Tone 787/wintergreen oil conc. (60 wt %)# | 4 wt % |
| 4^{th} layer | PLA*** | 46 wt % |

*Capa FB100 is a high molecular weight polyester containing polycaprolactone from Union Carbide
**see Example 17
# similar to Example 17 with wintergreen substituted for cedar oil
***see Example 11

This film illustrates that a film may be made if four extruders are available; if only three extruders are available then both cedar oil concentrate and wintergreen concentrate are added to a single extruder to produce a film with more than one essential oil in the center layer(s).

### EXAMPLE 19

A blown non-degradable mulch multi-layer film is illustrated as follows:

| | | |
|---|---|---|
| 1^{st} layer | EVA* | 48 wt % |
| 2^{nd} layer | LDPE** | 48 wt % |
| 3^{rd} layer | LDPE/cedar oil conc. (60 wt %)\hat{ } | 4 wt % |

*see example 15
**LDPE is a low density polyethylene from Westlake
\hat{ }see Example 5E

This example illustrate that the essential oil layer may be an outside layer that is to provide the maximum exposure for the intended use, e.g. laid with that layer on the ground (bottom) to dispel the insects in the ground.

### EXAMPLE 20

Another three layer blown non-degradable mulch film is illustrated as follows:

| | | |
|---|---|---|
| 1^{st} layer | LDPE* | 48 wt % |
| 2^{nd} layer | LDPE/cedar oil conc.\hat{ } | 2 wt % |
| 2^{nd} layer | LDPE/wintergreen conc.\hat{ } | 2 wt % |
| 3^{rd} layer | EVA** | 48 wt % |

*LDPE is a low density polyethylene from Westlake
**see Example 15
\hat{ }see Example 5E and similar to Example 5E with wintergreen substituted for cedar oil

This film illustrates a film with more than one essential oil.

### EXAMPLE 21

Another three layer blown non-degradable mulch film is illustrated as follows:

| | | |
|---|---|---|
| 1^{st} layer | LDPE white* | 48 wt % |
| 2^{nd} layer | EVA/cedar oil concentrate\hat{ } | 4 wt % |
| 3^{rd} layer | LDPE** | 48 wt % |

*LDPE is a low density polyethylene containing titanium dioxide (TiO2)
\hat{ }similar Example 5E with EVA substituted for LDPE
**LDPE from Westlake

This example illustrates the simplest approach to provide a barrier layer to the layer containing the essential oil.

The film of the present inventions may be cast rather than blown. The advantage of cast films are that different resins may be handled easily to make multi-layer films as illustrated by the following examples.

### EXAMPLE 22

A multi-layer cast film is illustrated as follows:

| | | |
|---|---|---|
| 1^{st} layer | HGZ 120-01* | 96 wt % |
| 2^{nd} layer | LDPE/cedar oil conc. (60 wt %)\hat{ } | 4 wt % |

*HGZ 120-01 is a polypropylene from Phillips
\hat{ }see Example 5

### EXAMPLE 23

A three layer cast film is illustrated as follows:

| | | |
|---|---|---|
| 1^{st} layer | HGZ 120-01* | 48 wt % |
| 2^{nd} layer | LDPE/cedar oil conc. (60 wt %) | 4 wt % |
| 3^{rd} layer | HGZ 120-01* | 48 wt % |

*HGZ 120-01 is a polypropylene from Phillips
see Example 5E

### EXAMPLE 24

A four layer cast film is illustrated as follows:

| | | |
|---|---|---|
| 1^{st} layer | HGZ 129-01* | 20 wt % |
| 2^{nd} layer | LDPE** | 20 wt % |
| 3^{rd} layer | EVA/cedar oil conc. (60 wt %)\hat{ } | 5 wt % |
| 4^{th} layer | Surlyn*** | 55 wt % |

*HGZ 120-01 is a polypropylene from Phillips
**LDPE is from Westlake
\hat{ }see Example 21
***see Example 15

### EXAMPLE 25

A five layer cast film is illustrated as follows:

| | | |
|---|---|---|
| 1^{st} layer | HGZ 129-01* | 15 wt % |
| 2^{nd} layer | EVA** | 15 wt % |
| 3^{rd} layer | EVA/cedar oil conc. | 5 wt % |
| 4^{th} layer | Surlyn*** | 5 wt % |
| 5^{th} layer | LDPE | 60 wt % |

*HGZ 120-01 is a polypropylene from Phillips
**see Example 15
\hat{ }see Example 21
***see Example 15
****see Example 20

The foregoing examples are used for illustration of the present invention. The examples illustrate that one film resin may be substituted for another. The examples illustrate that essential oils may be substituted for one another or more than one essential oil may be used. The examples illustrate that varying thickness of films may be made from less than 0.5 mil to 1000 mils thick. The examples illustrate that the carrier material may be selected from a group of materials including porous resins (see Example 1), compounded resins (see Example 2), silica compounds (see Example 3), wax (see Example 4), styrene modified polymers (see Example 6), and natural or synthetic zeolites (see Example 9).

The examples of blown film also illustrate the productions of bags made from the films. As a tubular product the blown film may be easily made into bags by known procedures. Bags of the present invention are small bags such as for use to hold produce found in the grocery store to large bags that can hold 50 to 150 pounds.

There are two additional film-like products that are neither blown or cast in the equipment illustrated in FIGS. 1 or 2 but are made on known equipment. These products use equipment that produces strands or fiber-like material. The first product is a melt blown fiber or a spun fiber that is collected on a moving belt (processes developed by Exxon and DuPont respectively).

### EXAMPLE 26

In the production of a melt blown non-woven polypropylene film:

| | |
|---|---|
| HGZ 120-01* | 96 wt % |
| Concentrate containing wintergreen** | 4 wt % |

*HGZ 120-01 is a polypropylene from Phillips
**concentrate contains 60 wt % wintergreen and 49 wt % porous polypropylene MP100 from Akzo Nobel

The non-woven has incorporated in the film product wintergreen. These films are used in baby diapers as well as many other uses.

The other process is for making netting which is film-like in that the product is tubular. The process makes bags for onions and potatoes as well as other uses. The equipment has two extruders feeding die heads that rotate in opposite directions. The rotation and air movement causes the strands coming out the die heads to contact one another, but not in a continuous film, as a tubular product.

### EXAMPLE 27

A formulation as in Example 26 is employed in a netting apparatus. A bag made with the netting product is used as an onion bag to dispel bugs during storage of the onions.

The examples illustrate the present invention, with modifications available.

One modification of the films of the present invention is to introduce a ethylene absorber into the film to extend the shelf life of the produce placed in bags made with film containing essential oils or in liners made of the film. As pointed out above, it has been observed that a cedar oil containing bag or liner will extend the shelf life of bananas. The bananas covered by a cedar oil containing film keep the banana yellow and firm for days longer than the same film not having any oil in the film. The shelf live of bananas is also extended by including an ethylene absorber, such as potassium permanganate.

The following examples are directed to film to retard the fruit ripening process:

### EXAMPLE 28

| | 28A | 28B |
|---|---|---|
| LDPE* | 97.32 wt % | 95.56 wt % |
| Potassium permanganate | 0.45 wt % | 0.45 wt % |
| Molecular sieve | 2.23 wt % | 2.16 wt % |
| Cedar oil | 0 | 1.85 wt % |

The molecular sieve is used as a carrier for the potassium permanganate or potassium permanganate and cedar oil.

Films made of the above when used to cover bananas extended the shelf life for days compared to the same film without any ethylene absorber or oil. Levels of ethylene absorber in the final film may range from 0.1 wt % to 5 wt %.

1. A composition of matter for introducing into a plastic film forming extruder comprising:
a film grade resin; and
a concentrate for compounding with said resin comprising:
1 wt. % to 80 wt. % of an essential oil; and
1 wt. % to 60 wt. % of a carrier.

2. A composition according to claim 1 wherein said film grade resin is selected from the group consisting of a polyolefin, nylon, polycarbonate, polystyrene, and EVA.

3. A composition according to claim 1 wherein said essential oil is selected from the group consisting of cedar oil, citronella oil, eucalyptus oil, wintergreen oil and D-limonene.

4. A composition according to claim 1 wherein there is more than one essential oil.

5. A composition according to claim 1 wherein said carrier is selected from the group consisting of porous plastic resins, a compounded resin, a high surface area silica, wax, styrene modified polymers and natural or synthetic zeolites.

5. A plastic film made from a film grade resin containing:
an additive concentrate comprising
1 wt. % to 80 wt. % of an essential oil; and
1 wt. % to 50 wt. % of a carrier.

6. A film according to claim 5 wherein said film grade resin is selected from the group consisting of a polyolefin, nylon, polycarbonate, polystyrene, and EVA.

7. A film according to claim 5 wherein said essential oil is selected from-the group consisting of cedar oil, citronella oil, eucalyptus oil, wintergreen oil and D-limonene.

8. A film according to claim 5 wherein said carrier is selected from the group consisting of porous plastic resins, a compounded resin, a high surface area silica, wax, styrene modified polymers and natural or synthetic zeolites.

9. A film made from a biodegradable film grade resin containing:
an additive concentrate comprising
1 wt. % to 80 wt. % of an essential oil.

10. A multi-layer film wherein each layer of film is made from a film grade resin and at least one layer contains:
1 wt. % to 10 wt. % of an essential oil.

11. A multi-layer film according to claim 10 wherein there is more than one essential oil.

12. A multi-layer film according to claim 10 wherein said film is a blown film

13. A multi-layer film according to claim 10 wherein said film is a cast film.

14. A multi-layer film according to claim 10 wherein said layer includes a carrier selected from the group consisting of porous plastic resins, a compounded resin, a high surface area silica, wax, styrene modified polymers and natural or synthetic zeolites.

15. A multi-layer film according to claim 10 wherein film layers are on either side of the essential oil layer.

16. A multi-layer film according to claim 10 wherein said essential oil layer is an outside layer.

17. A multi-layer film according to claim 10 wherein said film resin is biodegradable.

18. A bag comprising:
a thin plastic film containing:
1 wt. % to 10 wt. % of an essential oil.

19. A bag according to claim 18 wherein said film contains a carrier selected from the group consisting of porous plastic resins, a compounded resin, a high surface area silica, wax, styrene modified polymers and natural or synthetic zeolites.

20. A bag according to claim 19 wherein said film is polyethylene.

21. A bag according to claim 18 wherein said essential oil is selected from the group consisting of cedar oil, citronella oil, eucalyptus oil, wintergreen oil and D-limonene.

22. A bag according to claim 18 wherein said bag is a banana bag for protecting bananas on the tree.

23. A bag according to claim 18 wherein said bag is woven.

24. A bag according to claim 23 wherein said film is polypropylene.

25. A bag according to claim 24 wherein said film contains cedar oil.

26. A bag according to claim 24 wherein said film contains more than one essential oil.

27. A non-woven melt blown or spun resin fiber collected as a film-like material, the Improvement comprising:
said resin fiber containing 0.5 wt % to 10 wt % of an essential oil.

28. A netting bag made from plastic resin, the improvement comprising:
said resin containing 0.5 wt % to 10 wt % of an essential oil.

29. A plastic film made from a film grade resin containing:
0.1 wt. % to 5 wt. % of an ethylene absorption agent.

30. A plastic bag according to claim 29 wherein said ethylene absorption agent is potassium permanganate.
